(19) United States
(12) Patent Application Publication
(10) Pub. No.: US 2017/0050409 A1
(43) Pub. Date: Feb. 23, 2017

(54) BUILDING FITTING THERMAL INSULATION AND WATER IN LOAD-BEARING STRUCTURES

(71) Applicant: PRZEDSIEBIORSTWO PRODUKCYJNO-HANDLOWO-USLUGOWE O.C.D, Bydgoszcz (PL)

(72) Inventor: Andrzej Ilnicki, Bydgoszcz (PL)

(21) Appl. No.: 14/834,243

(22) Filed: Aug. 24, 2015

(30) Foreign Application Priority Data
Aug. 22, 2015 (EP) 15460048.0

(51) Int. Cl. B32B 3/26; B32B 5/02; B32B 3/30; B32B 27/28

(52) U.S. Cl. CPC B32B 3/266; B32B 27/28; B32B 5/028; B32B 3/30; B32B 2307/304; B32B 2260/021; B32B 2260/046; B32B 2305/08; B32B 2262/101

(57) ABSTRACT

The present invention relates to molding equipment intended for thermal and water insulation in wall constructions, intended for the construction of buildings. Fitting has the form of a plate with a contour of a rectangular prism, and is composed of the core, element and the strengthening reinforcement layer. The side surfaces of the fittings are alternately—top, bottom, rectangular select—the projections, arranged at half height, over the entire length of the surface the short sides of the block, and the molding face has through holes for the studs arranged symmetrically over the entire surface at an equal distance, wherein the opening area is ≧10% of the total face of the molding. The outer layer is composed of a polymer cement and/or glue, which is submerged in a glass fiber mesh.

### PRIORITY CLAIM

The instant application claims priority as a continuation of European Utility Application EP15460048.0, filed on Aug. 22, 2015, presently pending, the contents of which are hereby incorporated by reference.

### FIELD OF THE INVENTION

The present invention relates to molding equipment intended for thermal insulation and water in wall constructions, intended for the construction of buildings.

### BACKGROUND OF THE INVENTION

There are known layered wall panels, e.g. in Polish Patent No. 95605, titled: the layered wall panel claddings, which being characterized in that it comprises two multi-layer, multi-material, composite load bearing liners separated by the inner core—wherein the liner is made of two different in terms of the mechanical properties composite materials complex technological.

From the Polish patent No. 170894 wall cladding of the building, which essence is that the thermal insulation between the core and the wall of the building is a layer of soft foam adhering closely to the walls of the building. This layer and the core insulation—forming a shaped body are connected together by foaming.

Also known is the wall plate insulated multi-layer description of Polish utility model Ru.22886. This element consists of the external cladding panels, a layer of thermal insulation, vapor barrier, to fill the void with concrete lining and the outer plates.

From Polish Patent No 197588 there is known a block of cellular concrete, consisting of two layers of concrete, characterized in that between the layers of concrete (1) and (2) there is arranged a perforated insert (3) with through holes (4), wherein the outer surfaces of the combined is a glue (5) with a concrete layer (4) and (2).

### SUMMARY OF THE INVENTION

The aim of the invention is to provide a new molded construction having good insulating and against moisture properties, simultaneously durability and strength, allowing for the use as a layer between the foundation and walls of the building, which is the thermal and water insulation between the foundation and the vertical wall, eliminating the moisture soaking and thermal bridges at the ceiling.

### BRIEF DESCRIPTION OF DRAWINGS

The invention together with the above and other objects and advantages will be best understood from the following detailed description of the preferred embodiment of the invention shown in the accompanying drawings, wherein:

FIG. 1 depicts a view of one embodiment of the invention;

FIG. 2 depicts a cross-section view of an embodiment of the invention;

FIG. 3 depicts a top view of one embodiment of the invention;

FIG. 4 depicts a top view of another embodiment of the invention; and

FIG. 5 depicts a top view of yet another embodiment of the invention.

### DETAILED DESCRIPTION

The essence of the invention is a fitting construction of the layer structure, which consists of a core of light material having good insulating properties, which has a series of holes in which the stiffening elements are arranged in the form of the material carrying the vertical load, and the bonding of the outer layer and the stiffening elements the entire structure while constituting a bonding layer to a connecting fittings welds, adhesives, etc. in the process of erecting buildings. Body is profiled and joined the length to “bookmark” in order to eliminate thermal bridges and water soaking in.

Fitting has the form of a plate with a contour cuboid shape and consists of a core 1, element 3 and the strengthening reinforcement layer 4, the side surfaces of the fittings have alternately—top, bottom, rectangular selected—projections 2, arranged at half height, over the entire length of the surface of less the sides of the block, and on the face of the fitting has holes to “caps” 3 constituting the filling mass of polymer concrete and are arranged symmetrically over the entire surface of the molding at an equal distance, the area of the openings relative to the surface of the plate is ≧10% of the total face of the molding. Fitting is made of extruded polystyrene, and the outer surfaces are covered with a molded outer layer 4, composed of a polymer cement and/or glue, which is submerged in a glass fiber mesh. Thus, a surface enhanced and well receiving any mortar. The use of such coverings with a thickness of 2-3 cm gives a perfect, smooth, impermeable and heat-insulating underlay for all linings.

The forms of the invention are characterized by low thermal conductivity, low water absorption, combined with high compressive strength, allow for a variety of uses panels of the invention minutes as wall insulation, but primarily as thermal insulation and water between the foundation and the vertical wall.

The use of panels removes soaking moisture from the foundation, fitting is resistant to water, due to the low degree of porosity of the concrete of the framework of the process there is no capillary “pull” water.

Plates are glued directly to the foundation, and walls are put on them puts, molded design allows the resignations of conduct thermal insulation of the foundation wall deep down to the level of foundations, because they eliminate thermal bridges at the ceiling. Composite molded parts have low value “k” which is equivalent to the value resulting from the thermal resistance in a vertical or two horizontal directions. Due to the specific use Blocks “wall” resulting value “k” is approx. 0.050 W/mK.

Fitting of the elements of reinforcement—“caps” polymer concrete transfers significant compressive stress in the foundation wall of the object, allowing for the construction of up to four ground floors and uniform distribution of reinforcing elements allows any crop molded in length depending on the needs without losing the strength of the whole structure.

They are also the ideal base for ceramic tiles on walls and floors, and even under finish. Fittings also have good acoustic properties, are resistant to mold, fungus, and are resistant to alkali.

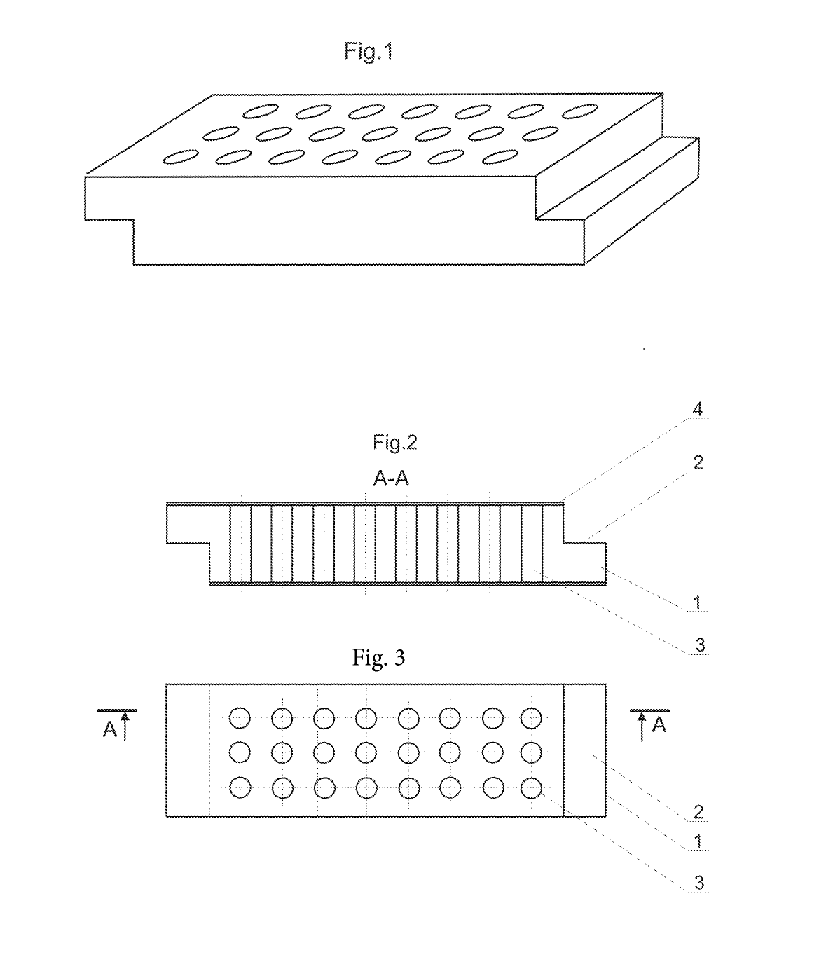

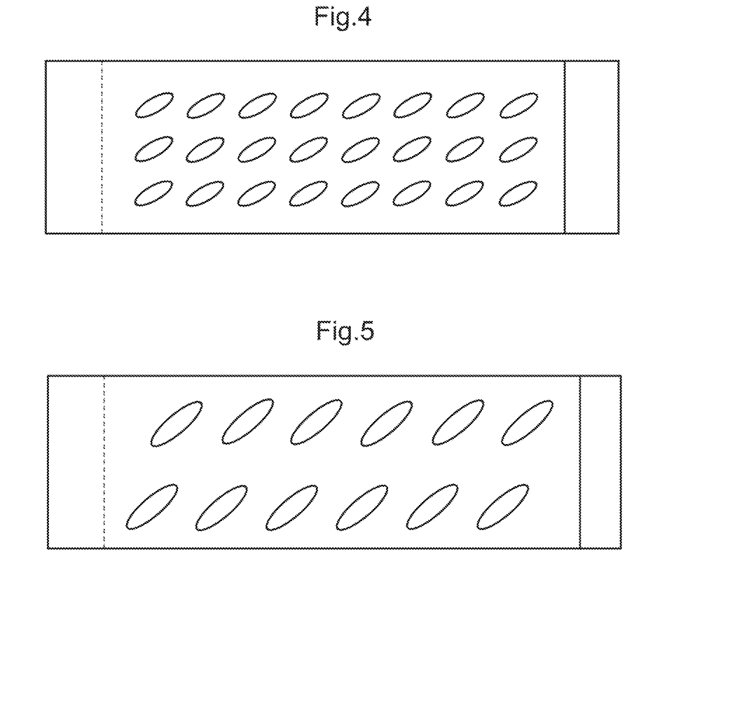

Fitting shown in more detail in an embodiment in which FIG. 1 shows the fitting in perspective view, FIG. 2 shows the fitting in cross section, and FIG. 3, 5 fitting in a top view.

In view of the present profiles of different widths, to maintain the same compression strength applied concrete filling holes with the surface of 3.14 cm²-9.0 cm², ie. In the core molding.

Fittings have the form of parallelepipeds with a length of 600 mm, 50 mm, or other and widths of 115/150/175/200/240 mm.

| | Length | | | | | | | % |
|---|---|---|---|---|---|---|---|---|
| Width | of | Area of | Amount | | | Area of 1 | Area of | equity |
| of fitting | fitting | fitting | of caps | Diameter | Radius | concrete cap | concrete | of |
| cm | cm | cm² | count | cm | cm | cm² | cm² | concrete |
| 11.50 | 60.00 | 690.00 | 16 | 2.50 | 1.25 | 4.9086 | 78.5375 | 11.38 |
| 15.00 | 60.00 | 900.00 | 24 | 2.50 | 1.25 | 4.9086 | 117.8063 | 13.09 |
| 17.50 | 60.00 | 1 050.00 | 24 | 2.50 | 1.25 | 4.9086 | 117.8063 | 11.22 |
| 24.00 | 60.00 | 1 440.00 | 32 | 2.50 | 1.25 | 4.9086 | 157.0750 | 10.91 |

Fitting 15 cm×60 cm with 24 “plugs” with a diameter of 2.5 cm

Fitting 15 cm×60 cm 12 “plugs” with dimensions 4.5 cm×2.0 cm

There is also possible set with the “caps” concrete in the shape of a rectangle or other figures, of course, respecting the principle of uniform distribution and ratio of surface to surface shaped holes

1. A fitting comprising a main body having a form of a plate with a contour cuboid shape, wherein the fitting main body comprises:
a core, at least one element and a strengthening reinforcement layer, wherein the fitting main body comprises top, bottom, and opposing side surfaces wherein projections, arranged at half height over the entire length of the surface of the shorter sides of the main body, and a molding face has through-hole filled with reinforcements in the form of caps, symmetrically distributed over the entire surface at an equal distance, wherein the opening area is ≧10% of the total face of the molding face and the outer layer comprises a polymer cement and/or glue, the glass fiber mesh.

2. Fitting according to claim 1, wherein in that the core is made of extruded polystyrene.

3. Fitting according to claim 1, wherein said caps comprise polymer concrete.
